(19) United States
(12) Patent Application Publication
(10) Pub. No.: US 2010/0023773 A1
(43) Pub. Date: Jan. 28, 2010

(54) SIGNATURE VERIFICATION APPARATUS, METHOD FOR CONTROLLING SIGNATURE VERIFICATION APPARATUS, SIGNING APPARATUS, METHOD FOR CONTROLLING SIGNING APPARATUS, PROGRAM, AND STORAGE MEDIUM

(75) Inventor: Shinji Todaka, Inagi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/755,308

(22) Filed: May 30, 2007

(30) Foreign Application Priority Data
Jun. 15, 2006 (JP) 2006-166201(PAT.)

(51) Int. Cl. H04L 9/32

(52) U.S. Cl. 713/176

(57) ABSTRACT

A signature verification apparatus includes a determining unit configured to determine a type of a signature affixed to a document file, a first generating unit configured to, when the determining unit determines that the signature is of a first type, check the validity of a certificate contained in the signature, detect whether the document file has been tampered with based on the signature, and generate a first verification result indicating whether the signature is valid based on the check and the detection, and a second generating unit configured to, when the determining unit determines that the signature is of a second type, without checking the validity of a certificate contained in the signature, detect whether the document file has been tampered with based on the signature, and generate a second verification result indicating whether the signature is valid based on the detection.

### BACKGROUND OF THE INVENTION

### Description of the Related Art

With the continuing development of our information society, electronic documents, such as electronic data created by a word processor and electronic forms converted from paper documents by being scanned by a copier or other devices, are increasingly being stored in document management systems.

As awareness of the need for security increases, authentication of the identification of such electronic documents by use of digital signatures and/or timestamp signatures is becoming popular.

The number of signatures affixed to a document is not limited to one, i.e., a single document can be affixed with a plurality of digital signatures and/or timestamp signatures. Therefore, a technique for collectively verifying multiple signatures in a document is becoming available. It is, of course, necessary to verify the validity of a certificate used for affixing each signature.

In order to verify the validity of a certificate of a signature affixed to a document file by an external significantly different system, there is a problem described below.

That is, in many cases, the validity of a certificate contained in a signature affixed by such an external system is doubtful. One reason is that it is often unknown whether a certificate server that issued the certificate updates sufficiently frequently a certificate revocation list (CRL), which is a list of certificates that have been revoked.

Japanese Patent Laid-Open No. 2003-046499 discloses a technique that can be used to verify a signature without distinguishing whether the signature has been affixed internally or externally. According to this technique, all externally affixed signatures are determined to be invalid as a result of verification, except when an issued certificate can be verified.

Therefore, most of the document files with externally affixed signatures are determined to be invalid.

### SUMMARY OF THE INVENTION

According to an aspect of the present invention, a signature verification apparatus includes a determining unit, a first generating unit, and a second generating unit. The determining unit is configured to determine a type of a first signature affixed to a document file. The first generating unit is configured to, when the determining unit determines that the first signature is of a first type, check the validity of a certificate contained in the first signature in the document file, detect whether the document file has been tampered with based on the first signature, and generate a first verification result indicating whether the first signature is valid or invalid based on the check and the detection. The second generating unit is configured to, when the determining unit determines that the first signature is of a second type, without checking the validity of a certificate contained in the first signature in the document file, detect whether the document file has been tampered with based on the first signature, and generate a second verification result indicating whether the first signature is valid or invalid based on the detection.

Further features of the present invention will become apparent from the following description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates a system configuration.

FIG. 2 illustrates how a dialog changes when a document registration apparatus captures and signs a document file and registers the document file into a document management server.

FIG. 3A is a flowchart that illustrates a process in which the document registration apparatus signs a document file and registers the document file into the document management server, FIG. 3B is a flowchart that illustrates a process of checking the validity of a certificate used for digital signing, FIG. 3C is a flowchart that illustrates a process of affixing a digital signature, and FIG. 3D is a flowchart that illustrates a process of affixing a timestamp signature.

FIG. 4A illustrates a document file that contains only an original document, FIG. 4B illustrates a document file that contains the original document and a first signature, FIG. 4C illustrates a document file that contains the original document, the first signature, and a second signature, FIG. 4D illustrates a document file that contains the original document, the first signature, the second signature, and edit information.

FIG. 5 illustrates how a dialog changes displayed on a display unit of a document verification apparatus when the document verification apparatus checks the validity of a document file registered in the document management server.

FIG. 6A is a flowchart that illustrates a process in which the document management server verifies a verification-target document file, FIG. 6B is a flowchart that illustrates a first process in which the document verification apparatus verifies an nth signature contained in the verification-target document file, FIG. 6C is a flowchart that illustrates a second process thereof, and FIG. 6D is a flowchart that illustrates a process in which the document verification apparatus integrates verification results.

FIG. 7 illustrates a screen showing verification results.

### DESCRIPTION OF THE EMBODIMENTS

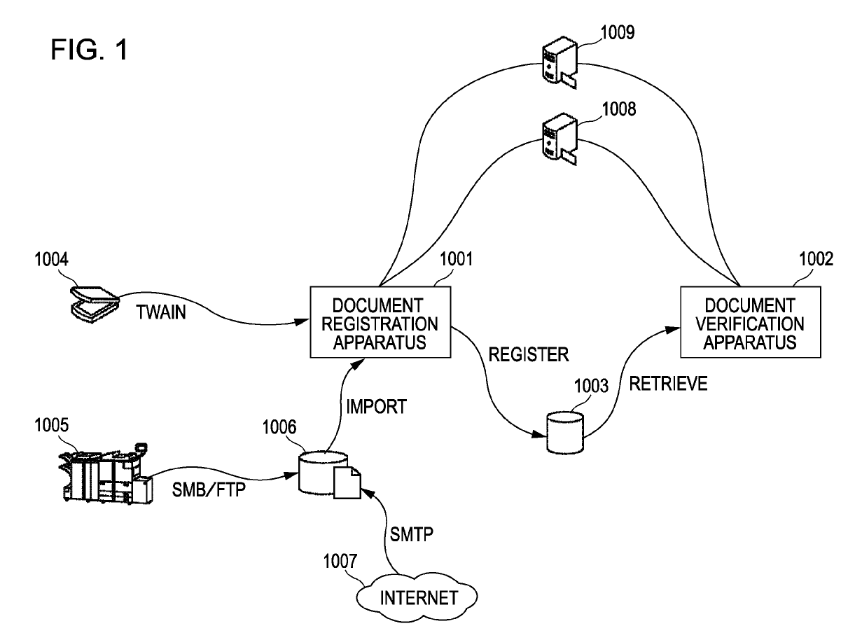

An exemplary embodiment will be described below with reference to the drawings. FIG. 1 illustrates a system configuration according to the exemplary embodiment. The system configuration according to the exemplary embodiment will be described with reference to FIG. 1.

A document management server 1003 stores various document files. The document management server 1003 can retrieve a desired document file from the stored document files as needed.

A document registration apparatus 1001 affixes a signature to a document file and thus generates a new document file. The document registration apparatus 1001 transmits the new document file to the document management server 1003 and causes the document management server 1003 to store the new document file. In the following description, “the document registration apparatus 1001 causes the document management server 1003 to store a document file” is referred to as “the document registration apparatus 1001 registers a document file into the document management server 1003.”

A document verification apparatus 1002 retrieves a document file stored in the document management server 1003 and checks the validity of a signature contained in the retrieved document file.

Each of the document management server 1003, the document registration apparatus 1001, and the document verification apparatus 1002 is subjected to centralized control by a central processing unit (CPU), not shown, incorporated therein.

In the specification, “digital signatures” and “timestamp signatures” are each one kind of “signature.” Therefore, an expression of “affixes a signature” and “signs” something in the specification indicates “affixes a digital signature,” “affixes a timestamp signature,” or “affixes both a digital signature and a timestamp signature.”

The document registration apparatus 1001 is connected to a scanner 1004 and has the capability of capturing a JPEG document file via the TWAIN. The document registration apparatus 1001 can further capture a document file stored in a shared storage device 1006. The shared storage device 1006 stores one or more document files e-mailed over the Internet 1007 and one or more document file transmitted from a multifunction device 1005 (hereinafter referred to as MFP 1005) via SMB or FTP transmission capabilities. The document files stored in the shared storage device 1006 include a document file that has not been signed and a document file that has been previously signed by another device. One of the most distinguishing characteristics of the invention is that a signature affixed within a system that includes the document management server and a signature that has been previously affixed by a device outside the system are subjected to different verification processes.

In FIG. 1, the document registration apparatus 1001 and the document verification apparatus 1002 are described as separate apparatuses. However, a single apparatus that has the capabilities of both apparatuses may be used.

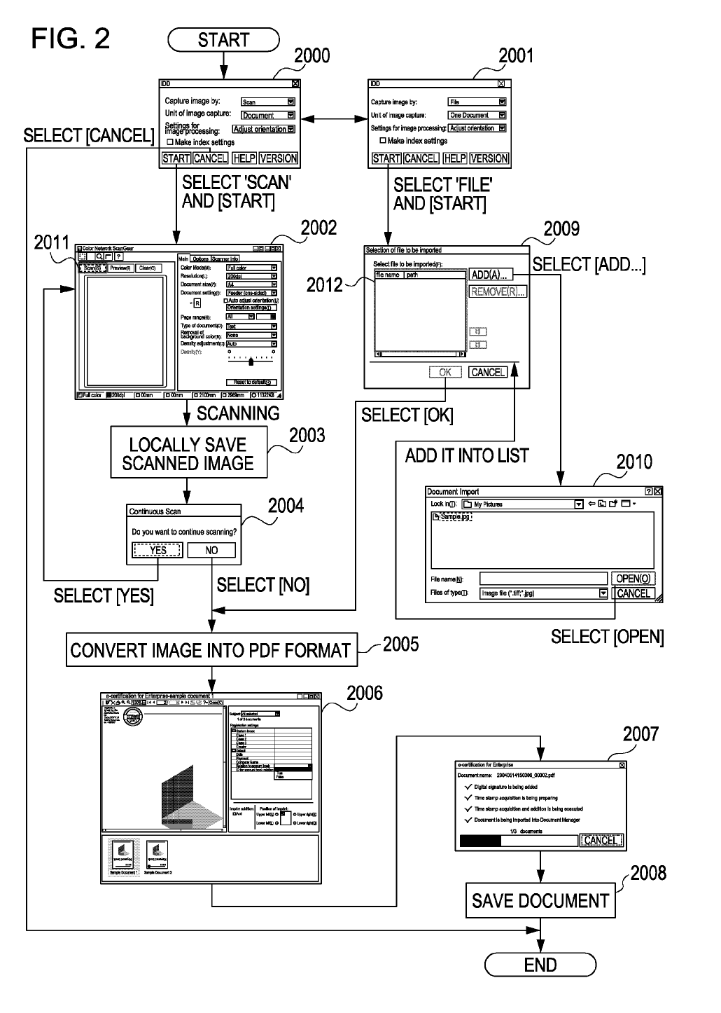

FIG. 2 illustrates how a dialog displayed on a display unit connected to the document registration apparatus 1001 changes when the document registration apparatus 1001 captures and signs a document file and registers the document file into the document management server 1003. A dialog 2000 is an initial dialog displayed on the display unit connected to the document registration apparatus 1001. A user can select either “SCAN” or “FILE” in the dialog 2000 using a keyboard and/or a mouse connected to the document registration apparatus 1001. If the user selects the “SCAN,” capturing a document file into the document registration apparatus 1001 by scanning is selected. If the user selects the “FILE,” capturing a document file stored in the shared storage device 1006 into the document registration apparatus 1001 is selected. A dialog 2001 is a dialog displayed when the user selects the “FILE” in the dialog 2000.

Here, it is assumed that the user selects the “SCAN” and then selects a “START” button in the dialog 2000. In this case, a scan dialog 2002 for prompting the user to specify various settings for scanning is displayed.

When the user specifies a color mode, a resolution, and other settings in the scan dialog 2002 and then selects a scan button 2011 in the scan dialog 2002, the scanner 1004 starts scanning. The scanner 1004 temporarily transmits a document file in scan image format (e.g., bmp or tiff format) to the document registration apparatus 1001. Then, as indicated at 2003, the document registration apparatus 1001 causes a predetermined storing unit incorporated therein to store the received document file in scan image format. The document registration apparatus 1001 displays, on the display unit, a continuous scan dialog 2004 for prompting the user to select continuing or stopping the scan.

When the user selects “YES” in the continuous scan dialog 2004, the document registration apparatus 1001 displays the scan dialog 2002 on the display unit. When the user selects “NO” in the continuous scan dialog 2004, the document registration apparatus 1001 converts the received document file in scan image format into PDF format to generate a PDF document file, as indicted at 2005. When the generation of the PDF document is complete, the document registration apparatus 1001 displays a preview dialog 2006 on the display unit.

The preview dialog 2006 is a dialog for previewing a PDF document file on the display unit. The user inputs index information and other data to be provided to the PDF document file in the preview dialog 2006. When the user selects “EXECUTE” in the preview dialog 2006 after completing input of the index information and other data, the document registration apparatus 1001 affixes a signature to the PDF document file and thus generates a new document file. The document registration apparatus 1001 registers the generated new document file into the document management server 1003. As described above, in the present embodiment, before a document file is registered into the document management server 1003, the document registration apparatus 1001 affixes a digital signature and a timestamp signature to the document file. In addition, at this time, the digital signature affixed by the document registration apparatus 1001 contains input optional information (a kind of identifying information). Only a digital signature affixed by the document registration apparatus 1001 immediately before a document file is registered into the document management server 1003 contains the input optional information. Even if another digital signature and timestamp signature is affixed or updated within the system after that, the input optional information is not newly provided. The reason is to avoid confusion based on the document verification apparatus 1002 determining whether a signature has been affixed internally or externally on the based on newest input optional information.

In the present embodiment, as will be described below, a signature affixed after a signature that contains the newest input optional information is affixed is determined to have been affixed within a system including the document registration apparatus 1001, the document management server 1003, and the document verification apparatus 1002. As described above, based on the newest input optional information, it can be distinguished whether a signature has been affixed internally or externally.

Whether a signature has been affixed internally or externally can be evident from “information unique to a signing apparatus” in a certificate contained in the signature, which will be described below. From this point of view, the provision of input optional information is meaningless. However, for a method of referring to the “information unique to a signing apparatus,” it is necessary to refer to the contents of all signatures in order to determine whether the signature has been affixed internally or externally.

In contrast to this, if the input optional information has been provided, it is not necessary to refer to the content of a signature affixed after the newest input optional information is found in order to detect the presence or absence of input optional information.

The reason why the term “newest” is attached to the term “input optional information” used herein will described briefly below.

It is assumed that a document file is input into the system, then temporarily transmitted to outside the system, and returned into the system again.

In this case, the document file has a plurality of pieces of input optional information. However, the document verification apparatus 1002 determines that, with respect to the document file that has been transmitted to outside once, a status of the document file before the document file is returned into the system again is determined to be an insecure one. Even if the signature has been affixed internally, the document verification apparatus 1002 is designed to make such a determination.

Therefore, the document verification apparatus 1002 uses only the newest piece of the plurality of pieces of input optional information.

The document registration apparatus 1001 displays a processing-status display dialog 2007 for indicating a current processing-status on the display unit until registration of all the document files into the document management server 1003 has been completed. When the registration of all the document files has been completed, the document registration apparatus 1001 dismisses the processing-status display dialog 2007 from the display unit. This can be done by saving the document 2008 or cancelling the process.

If the user selects the “FILE” and then selects the “START” button in the dialog 2000, a dialog 2009 for prompting the user to select a file to be captured is displayed.

If the user selects “ADD . . . ” in the dialog 2009, the document registration apparatus 1001 displays, on the display unit, a dialog 2010 for prompting the user to specify an image file. In this state, when the user specifies a desired file, the document registration apparatus 1001 displays the dialog 2009 on the display unit again. An area 2012 in the dialog 2009 lists the names of one or more document files specified by the user.

When the user selects “OK” in the dialog 2009, the document registration apparatus 1001 converts each of the document files listed in the area 2012 into a PDF document file. The documents are then converted to PDF 2005. The remaining processing for FILE is the same as that described above for SCAN.

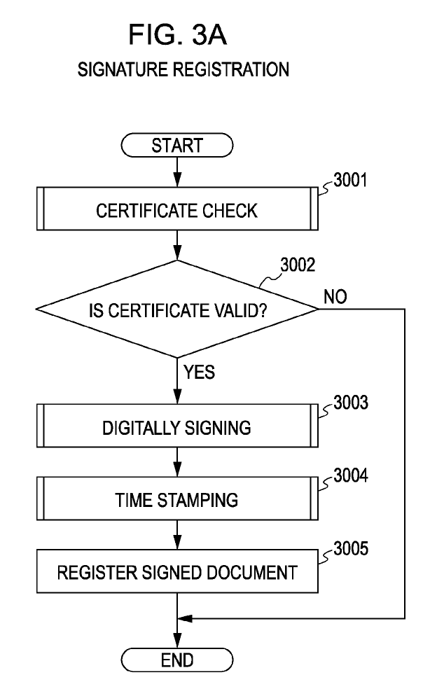

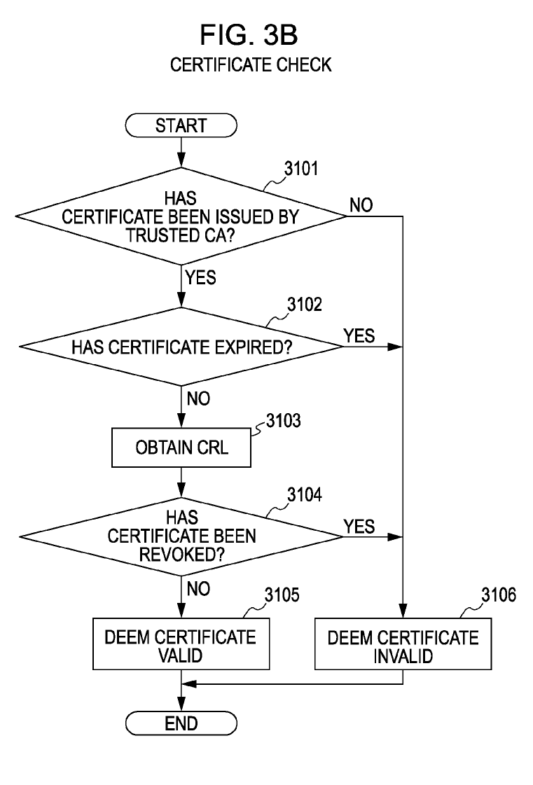

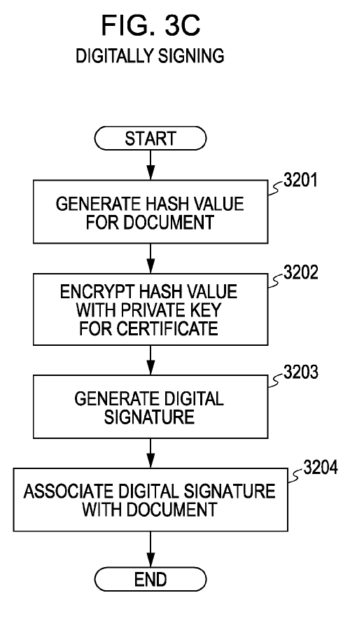

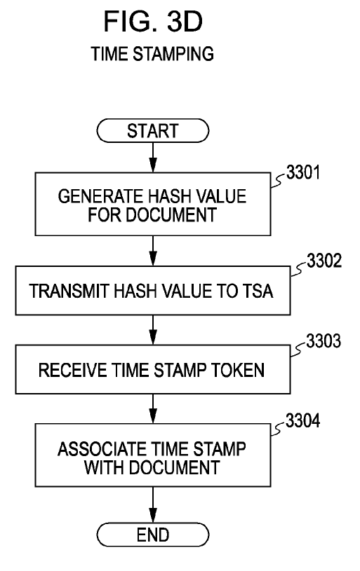

FIG. 3A is a flowchart that illustrates a process in which the document registration apparatus 1001 signs a document file and registers the document file into the document management server. The document registration apparatus 1001 executing the processing in this flowchart is subjected to centralized control of a CPU (not shown) incorporated therein.

Before the processing illustrated in this flowchart starts, a hash function, a private key, and a certificate associated with the private key are stored in advance in a storing unit within the document registration apparatus 1001. The hash function, the private key, and the certificate are used for digital signing, not for timestamp signing. Information used for timestamp signing (e.g., hash function, private key, and certificate) is stored in a timestamp server (time-stamping authority (TSA)) 1008, not in the document registration apparatus 1001.

The certificate used for digital signing contains a public key. The certificate used for digital signing also has information, such as a serial number of the certificate used for digital signing, a period of validity thereof, and information unique to a signing apparatus that affixes the signature. Examples of the information unique to a signing apparatus that affixes the signature include an IP address of the document registration apparatus 1001 itself and a name thereof.

In step 3001, the document registration apparatus 1001 checks the validity of a certificate to be used for digital signing (hereinafter referred to as a target certificate). The process of checking the validity of the target certificate will be described below with reference to FIG. 3B.

In step 3002, if the target certificate is determined to be valid in step 3001, flow proceeds to step 3003; if it is determined to be invalid, the processing in this flowchart ends.

In step 3003, the document registration apparatus 1001 affixes a digital signature to a document file using the target certificate whose validity has been verified, thus generating a new document file. The process of affixing the digital signature will be described below with reference to FIG. 3C.

In step 3004, the document registration apparatus 1001 affixes a timestamp signature to the document file generated in step 3003, thus generating a further new document file. The process of affixing the timestamp signature will be described below with reference to FIG. 3D.

In step 3005, the document registration apparatus 1001 registers the document file generated in step 3004 into the document management server 1003. In the present embodiment, a digital signature and a timestamp signature are affixed to a document file, and the document file with the digital signature and the timestamp signature is generated as a new file. However, it is not necessarily required to generate a new document file. For example, a document file prior to being signed, a digital signature, and a timestamp signature may be registered as different files associated with one another.

In the event that an error occurs during the processing of step 3003 (affixing a digital signature), processing of step 3004 (affixing a timestamp signature), or processing of step 3005 (registering a document file), the error is properly handled.

The processing of step 3001 (checking the validity of a certificate used for digital signing) will now be described in greater detail with reference to FIG. 3B.

In step 3101, the document registration apparatus 1001 determines an issuer of the target certificate. In addition, the document registration apparatus 1001 determines whether the issuer is a trusted certificate server (certificate authority). With respect to which server is a trusted one, information thereon is previously registered in an operating system in the document management server 1003. If the issuer is determined to be a trusted one, flow proceeds to step 3102. If the issuer is determined not to be a trusted one, flow proceeds to step 3106, where the status of the target certificate is deemed to be invalid. In the present embodiment, a certificate server 1009 is considered as a trusted certificate server unless otherwise specified. Similarly, in the present embodiment, the certificate server 1009 is considered as the issuer of each certificate unless otherwise specified.

In step 3102, the document registration apparatus determines whether the period of validity described in the target certificate has expired. If the period of validity has expired, flow proceeds to step 3106, where the status of the target certificate is deemed to be invalid. If the period of validity has not expired, flow proceeds to step 3103.

In step 3103, the document registration apparatus obtains a CRL, which is a list of certificates that have been revoked, from the certificate server 1009, which is the issuer of the target certificate.

In step 3104, the document registration apparatus determines whether the target certificate is included in the CRL. If the target certificate is determined to be included, which means that the target certificate has been revoked, flow proceeds to step 3106, where the status of the target certificate is deemed to be invalid. If the target certificate is determined not to be included, flow proceeds to step 3105, where the status of the target certificate is deemed to be valid.

The processing of step 3003 (affixing a digital signature) will now be described in greater detail with reference to FIG. 3C.

In step 3201, the document registration apparatus 1001 calculates a hash value for the document file. A hash function for use in calculation of the hash value can be, for example, a publicly known technique, such as MD5 and SHA-1.

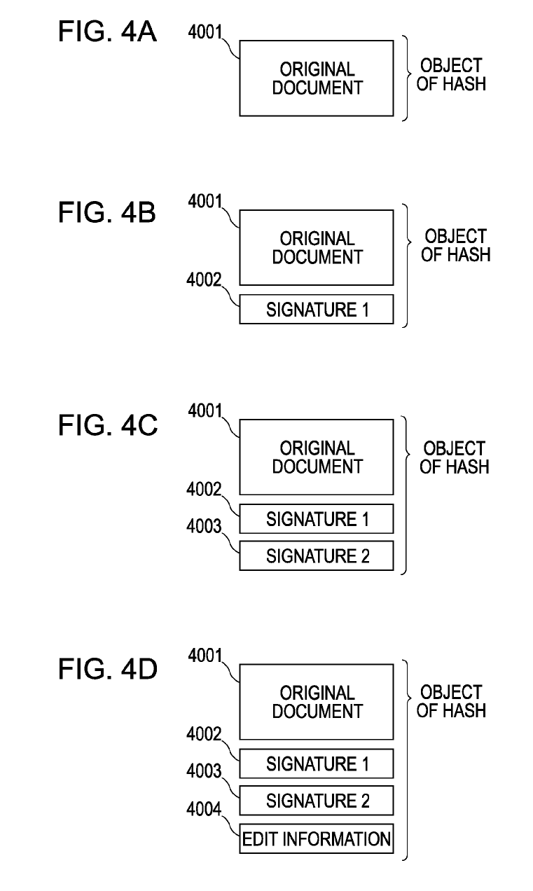

If the document file has already contained a signature (timestamp signature and/or digital signature) at the time of step 3201, the hash value is calculated such that the signature is included. This will be described with reference to FIGS. 4A to 4D.

A document file illustrated in FIG. 4A contains only an original document 4001 (has not been affixed with a signature). To affix a digital signature to the document file, the hash value is calculated with respect to only the original document 4001. When the document registration apparatus 1001 performs the processing illustrated in FIG. 3A on the document file illustrated in FIG. 4A and a digital signature (signature 1) is thus affixed to the document file, a document file illustrated in FIG. 4B is generated.

The document file illustrated in FIG. 4B contains the original document 4001 and the digital signature 1. To affix a further digital signature to the document file, the hash value is calculated with respect to both the original document 4001 and the initial signature 1. When the document registration apparatus 1001 performs the processing illustrated in FIG. 3A on the document file illustrated in FIG. 4A and a digital signature (signature 2) is thus affixed to the document file, a document file illustrated in FIG. 4C is generated.

The document file illustrated in FIG. 4C contains the original document 4001, the digital signature 1 (4002), and the signature 2 (4003).

Referring back to FIG. 3C, in step 3202, the document registration apparatus 1001 encrypts the hash value calculated in step 3201 with a private key contained in the target certificate.

In step 3203, the document registration apparatus 1001 generates a digital signature that contains the encrypted hash value and the target certificate. Examples of the form of the digital signature include PKCS #7 and PDF signature from Adobe Systems Incorporated. The document registration apparatus 1001 may generate a digital signature such that information indicating that the document file is to be registered into the document management server 1003 and a time of generation of the digital signature are further contained therein.

In step 3204, the digital signature generated in step 3203 is affixed to the document file and thus a new document file is generated. In the present embodiment, two files of the digital signature and the original document file are combined into a new single document file. However, a method for affixing a signature is not limited to this combining. For example, it may be used to merely associate two files of a digital signature and an original document file with each other without actually combining them together.

The processing of step 3004 (affixing a timestamp signature) will now be described in greater detail with reference to FIG. 3D.

In step 3301, the document registration apparatus 1001 calculates a hash value for the digitally signed document file generated in step 3003.

It is assumed that a document file prior to being affixed with a digital signature in step 3003 (step of affixing a digital signature) is a document file that contains only the original document 4001, as illustrated in FIG. 4A. In this case, in step 3003, a document file that contains the original document 4001 and the signature 1 (4002), as illustrated in FIG. 4B, is generated. As a result, in step 3301, a hash value is calculated with respect to both the original document 4001 and the signature 1 (4002).

In step 3302, the hash value calculated in step 3301 is transmitted to the TSA 1008.

The TSA 1008 encrypts the received hash value with a private key unique to the TSA 1008. The TSA 1008 integrates the encrypted hash value and a current time to generate integrated information. Then, the TSA 1008 generates a timestamp token such that the integrated information and a certificate that contains a public key associated with the private key are contained in the timestamp token. When the generation of the time-stamp token is complete, the TSA 1008 returns the time-stamp token to the document registration apparatus 1001.

In step 3303, the document registration apparatus 1001 receives the sent time-stamp token.

In step 3304, a timestamp signature is generated such that the received time-stamp token and other necessary information are contained therein. The generated timestamp signature is affixed to the digitally signed document file generated in step 3003, thus generating a new document file. As described in step 3204, the term “affixing” and “signing” includes combining and associating.

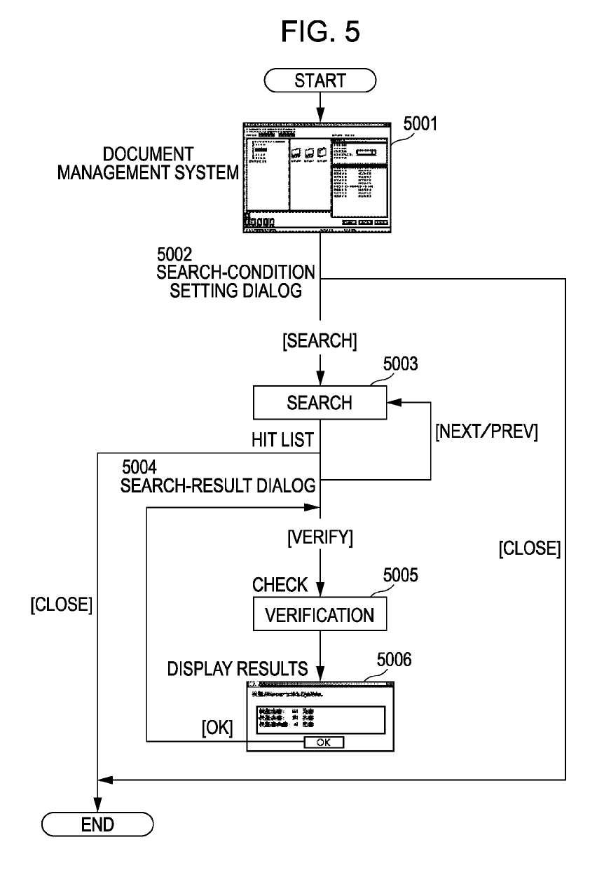

FIG. 5 illustrates how a dialog displayed on the display unit connected to the document verification apparatus 1002 changes when the document verification apparatus 1002 checks the validity of a document file registered in the document management server 1003.

A dialog 5001 is a dialog for displaying the names of signed document files that are stored in the document management server 1003. The document verification apparatus 1002 displays the dialog 5001 on the display unit thereof.

A search-condition setting dialog 5002 is a dialog displayed by the document verification apparatus 1002 to prompt the user to specify a search condition for searching the document files registered in the document management server 1003 for a desired document file.

When the user selects “CLOSE” in the search-condition setting dialog 5002, the processing in this flowchart ends.

When the user specifies a search condition and then selects “SEARCH” in the search-condition setting dialog 5002, the document verification apparatus 1002 informs the document management server 1003 of the search condition. Then, the document management server 1003 searches the documents stored therein in accordance with the search condition. The document management server 1003 transmits a plurality of document files as a result of the search to the document verification apparatus 1002. The document verification apparatus 1002 receives the search result and displays it on the display unit in the form of a search-result dialog 5004.

The search-result dialog 5004 displays the names of a user preset number of document files. When the user selects “NEXT/PREV” in the search-result dialog 5004, the document management server 1003 performs a search again. The result of the search is displayed on the display unit of the document verification apparatus 1002 in the form of the search-result dialog 5004.

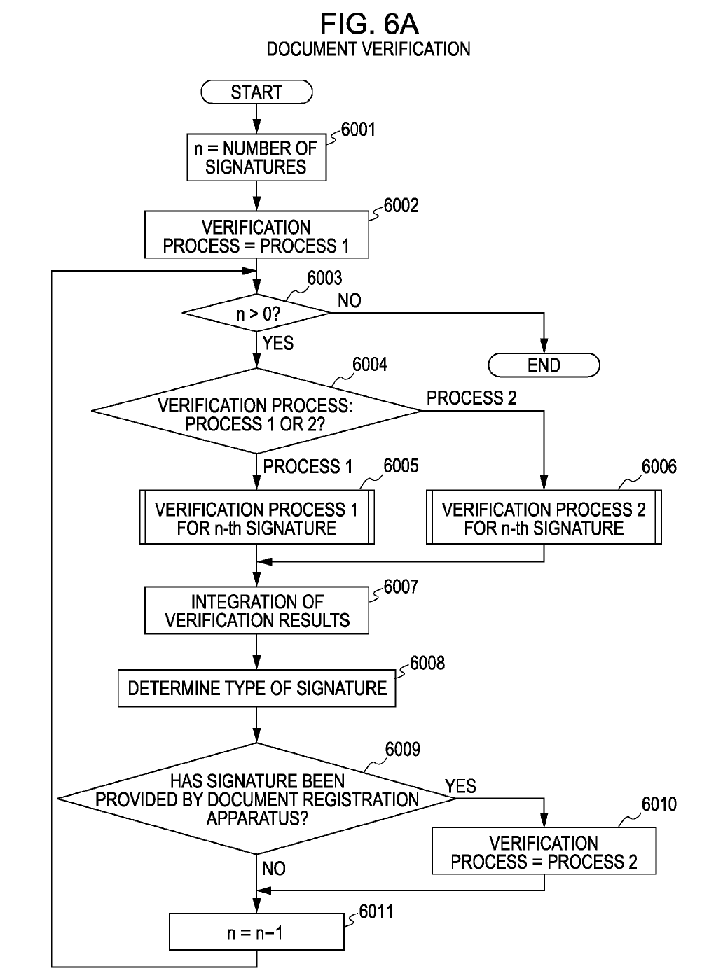

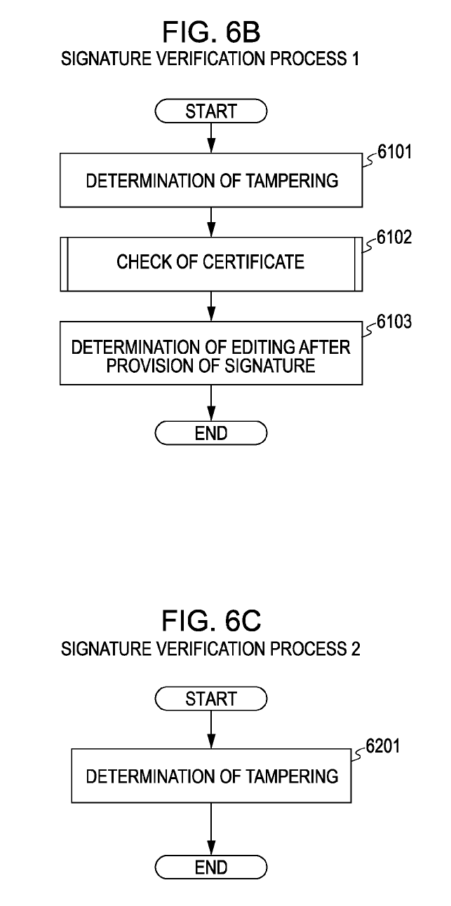

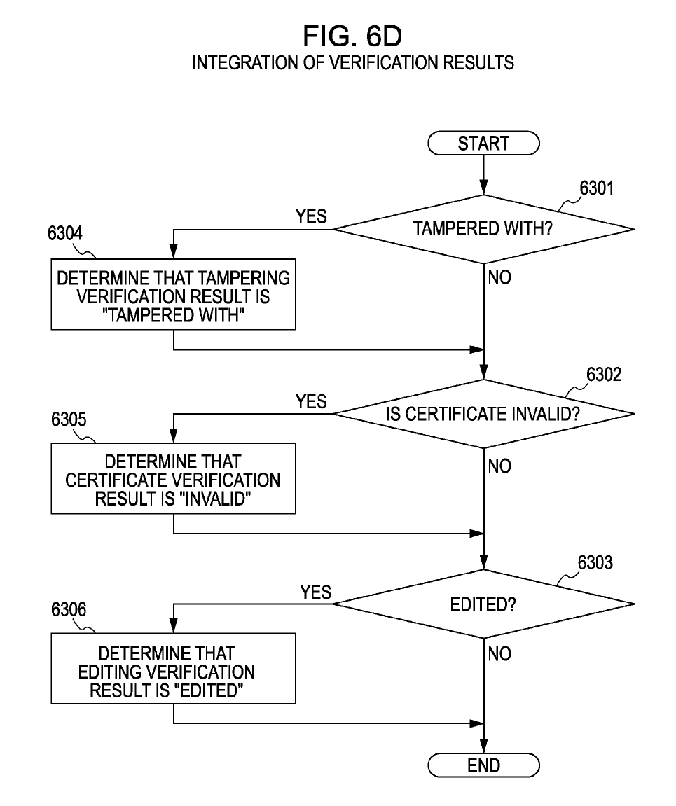

When the user selects “VERIFY” in the search-result dialog 5004, the document verification apparatus 1002 verifies a plurality of document files retrieved as the search result 5005 and displays the result of the verification in a verification-result dialog 5006. The process of the verification will be described below with reference to FIG. 6A.

When the user selects “OK” in the verification-result dialog 5006, flow returns to the search-result dialog 5004. In the search-result dialog 5004, a verification result corresponding to each document file is newly displayed in the same line as in the name of the document file.

FIG. 6A is a flowchart that illustrates a process performed when the validity of a document file having n signatures is checked. The document verification apparatus 1002 executing the processing in this flowchart is subjected to centralized control of a CPU (not shown) incorporated therein.

The document verification apparatus 1002 determines a document file to be subjected to verification and starts the verification of the document file. The document file determined as a document file to be subjected to verification is hereinafter referred to as a verification-target document file. The verification performed on the verification-target document file is determined by the validity of each signature contained in the verification-target document file.

In step 6001, the document verification apparatus 1002 counts the number of signatures contained in the verification-target document file and sets the count as n. The signatures contained in the verification-target document file are serially numbered in chronological order. For example, the signature 1 (4002) in the document file illustrated in FIG. 4C is numbered 1, and the signature 2 (4003) is numbered 2. As described above, the signatures are serially numbered in chronological order, and in step 6003 and subsequent steps, verification starts from a newest signature.

In step 6002, the document verification apparatus 1002 sets a process 1 as the initial verification process.

In step 6003, the document verification apparatus 1002 determines whether n is a positive number. If n is zero, i.e., there is no signature to be verified, the document verification apparatus 1002 finishes the verification to the verification-target document file. If n is one or more, i.e., a signature to be verified exists, flow proceeds to step 6004.

In step 6004, the document verification apparatus 1002 determines the set verification process. If the process 1 is set, the document verification apparatus 1002 performs a signature verification process 1 on an nth signature in step 6005; if a process 2 is set, the document verification apparatus 1002 performs a signature verification process 2 on an nth signature in step 6006. The signature verification process 1 will be described below with reference to FIG. 6B. The signature verification process 2 will be described below with reference to FIG. 6C. In step 6004, the newest signature in the verification-target document file is subjected to verification in accordance with the process 1, which is set in step 6002. The reason why the newest signature is always subjected to verification in accordance with the process 1 is that the newest signature in the document file is always affixed within the document registration apparatus 1001. This premise has been described with reference to FIG. 2. More specifically, it has been described as in “as described above, in the present embodiment, before a document file is registered into the document management server 1003, the document registration apparatus 1001 affixes a digital signature and a timestamp signature to the document file.”

In step 6007, the document verification apparatus 1002 finds a result of verification to the verification-target document file (hereinafter referred to as integration of verification results) on the basis of the verification of the nth signature. The integration of verification results will be described below with reference to FIG. 6D. The “verification results” determined by the integration of verification results are classified into “valid” and “invalid.” The result “invalid” is classified as three kinds: “invalid certificate,” “edited,” and “tampered with.” The result “valid” indicates that, with respect to all signatures in a document file, tampering has not been performed, a certificate of each signature is valid, and editing has not been performed after the document file has been signed.

In step 6008, the document verification apparatus 1002 determines a type of the nth signature on basis of the input optional information. If the nth signature contains the input optional information, the signature type is determined to be “a signature affixed by a device outside a system that includes the document verification apparatus 1002.” The reason of making this determination will be described next.

As previously described, the input optional information is provided to only a digital signature affixed by the document registration apparatus 1001 when the document file is input from an external device into the document registration apparatus 1001. Therefore, if the nth signature contains input optional information, an (n−1)th signature (i.e., a signature affixed immediately before the nth signature) is determined to have been affixed to a document file prior to being input to the document registration apparatus 1001. Therefore, the signature type is determined to be “a signature affixed by a device outside a system that includes the document verification apparatus 1002.”

As a result, once the input optional information has been detected, the signature verification process in step 6008 will be simplified. Once the input optional information has been detected, the document verification apparatus 1002 can determine the signature type as “a signature affixed by a device outside a system that includes the document verification apparatus 1002” thereafter without referring to the input optional information.

In step 6009, the document verification apparatus 1002 makes a determination on the basis of the result of the signature type determination in step 6008. If the signature is determined to have been affixed by the document registration apparatus 1001, flow proceeds to step 6010.

In step 6010, the document verification apparatus 1002 sets the process 2 as the verification process, and flow proceeds to step 6011. In the present embodiment, as shown in FIG. 6C, once the process 2 is set, the verification process is not changed to the process 1. Therefore, if there is a signature that is determined as “a signature affixed by a device outside a system that includes the document verification apparatus 1002” in a verification-target document file, signatures affixed before the determined signature are continuously subjected to verification in accordance with the process 2. In step 6011, a number in which 1 is subtracted from n is set as new n, and flow returns to step 6003. When flow returns to step 6003, although the value of n is reduced, the setting of the process (process 1 or 2) is not changed.

As described above, all signatures in a document file are subjected to the verification to obtain a final verification result to the document file. The final verification result is the same as a verification result determined in step 6007 (integration of verification results) where n=1.

The verification of an nth signature in a verification-target document file in accordance with the process 1 will now be described with reference to a flowchart illustrated in FIG. 6B. FIG. 6B is a flowchart occurring when the document verification apparatus 1002 verifies the nth signature contained in the verification-target document file in accordance with the process 1. The document verification apparatus 1002 executing the processing in this flowchart is subjected to centralized control of the CPU (not shown) incorporated therein.

Before the flowchart is described, the terms “tampering” and “editing” are defined.

The term “tampering” indicates incorrectly altering a document file that contains a signature. For example, an action of opening a document file that contains a signature in binary format and altering binary data (e.g., changing a bit from 0 to 1) is included in an action of “tampering.”

The term “editing” indicates modifying a document file that contains a signature in a non-fraudulent manner. For example, an action of opening a document file that contains a signature in PDF format, modifying the original document in the PDF data, and adding information that indicates which modifications has been made to the document file is included in an action of “editing.”

In other words, “tampering” is an action of changing data such that information before being tampered with is lost, and “editing” is an action of changing data such that information before being edited is not lost. The “information that indicates which modifications has been made,” described above, is referred to as “edit information” in the specification. The further details of the foregoing processing will be described with reference to FIGS. 4C and 4D. When a document file illustrated in FIG. 4C is edited, edit information 4004 is added and thus a document file illustrated in FIG. 4D is generated.

Referring to FIG. 6B, in step 6101, the document verification apparatus 1002 determines whether the verification-target document file has been tampered with in the period from after the nth signature has been affixed to before the (n+1)th signature affixed. When the nth signature is the newest signature in the verification-target document file, in step 6101, the document verification apparatus 1002 determines whether the verification-target document file has been tampered with after the nth signature has been affixed. Therefore, when the nth signature is the newest signature, since an (n+1)th signature does not exist, it is checked whether the verification-target document file has been tampered with out considering an (n+1)th signature.

The details of processing in step 6101 when the nth signature is a digital signature are described below. First, the document verification apparatus 1002 decrypts a hash value contained in the nth signature (digital signature) with a public key in a certificate contained in the nth signature (digital signature). In addition, the document verification apparatus 1002 calculates a hash value from a document file prior to being affixed with the nth signature (digital signature). The document verification apparatus 1002 compares the decrypted hash value and the calculated hash value. If the two hash values are different, the document verification apparatus 1002 determines that the document file has been tampered with. If the two hash values are the same, the document verification apparatus 1002 determines that the document file has not been tampered with.

If the nth signature is a timestamp signature, the details of processing in step 6101 are described below.

First, the document verification apparatus 1002 decrypts a hash value in a time-stamp token contained in the nth signature (timestamp signature) with a public key contained in the nth signature (timestamp signature). The document verification apparatus 1002 calculates a hash value from a document file prior to being affixed with the nth signature (timestamp signature). The document verification apparatus 1002 compares the decrypted hash value and the calculated hash value. If the two hash values are different, the document verification apparatus 1002 determines that the document file has been tampered with. If the two hash values are the same, the document verification apparatus 1002 determines that the document file has not been tampered with.

In step 6102, the document verification apparatus 1002 checks the validity of a certificate contained in the nth signature.

If the nth signature is a digital signature, the details of processing in step 6102 are substantially the same as in the verification of a certificate described with reference to FIG. 3B. However, the document registration apparatus 1001 performs the verification in FIG. 3B, whereas the document verification apparatus 1002 performs the processing in step 6102 in FIG. 6B. In FIG. 3B, whenever the period of validity of a certificate expires at the time of checking the validity of the certificate, the status of the certificate is deemed to be invalid. In contrast to this, in step 6102, even if the period of validity of a certificate expires at the time of checking the validity of the certificate, when a timestamp signature is affixed before the expiration of this period, the status of the certificate is deemed to be valid.

When the nth signature is a timestamp signature, in step 6101, it is checked whether the timestamp signature is valid on the basis of a period of validity described in a time-stamp token contained in the timestamp signature. As in the case of the digital signature, when a new timestamp signature is affixed before the expiration of this period, the timestamp signature is deemed to be valid.

In step 6103, the document verification apparatus 1002 determines whether the original document has been edited after the nth signature has been affixed. This determination is made on the basis of whether edit information is contained in the verification-target document file, as illustrated in FIG. 4D.

The verification of an nth signature in a verification-target document file in accordance with the process 2 will now be described with reference to a flowchart illustrated in FIG. 6C. FIG. 6C is a flowchart occurring when the document verification apparatus 1002 verifies the nth signature contained in the verification-target document file in accordance with the process 2. The document verification apparatus 1002 executing the processing in this flowchart is subjected to centralized control of the CPU (not shown) incorporated therein.

In step 6201, the document verification apparatus 1002 determines whether the verification-target document file has been tampered with in a period after the nth signature has been affixed and before the (n+1)th signature has been affixed. This processing is substantially the same as in the processing in step 6101 in FIG. 6B. If the processing in step 6201 is complete, the processing in FIG. 6C ends.

As described above, in step 6006 (signature verification in accordance with the process 2 in FIG. 6C), only detection of tampering is performed, without checking the validity of a certificate and detecting the presence of editing after the document file is signed, and the processing ends. The simplified verification in accordance with the process 2 is performed on a signature affixed in the verification-target document file by a device other than the document registration apparatus 1001, as previously described. In addition, with respect to a signature affixed before this signature is affixed, the simplified verification in accordance with the process 2 is performed.

As described above, in contrast to the signature verification 1, illustrated in FIG. 6B, the signature verification 2, illustrated in FIG. 6C, does not verify the validity of a certificate. This is because it is unknown whether a certificate contained in a signature affixed before the document file is input to the document registration apparatus 1001 was issued by a trusted server.

In other words, the document verification apparatus 1002 does not verify the validity of a certificate contained in a signature affixed in an unknown place. This is because it is unknown whether such a certificate was issued by a trusted entity and whether the issuer of the certificate can be accessed.

As described with reference to FIGS. 6A, 6B, and 6C, in the present embodiment, the method for verifying a signature is switched depending on whether the signature was affixed by the document registration apparatus 1001 or a device other than the document registration apparatus 1001. For example, a document file having the signature 1 (4002) is a signature affixed by a device other than the document registration apparatus 1001 and the signature 2 (4003) is a signature affixed by the document registration apparatus 1001, as illustrated in FIG. 4C, is assumed. If such a document file is subjected to the verification performed by the document verification apparatus 1002, the signature 1 undergoes a process illustrated in FIG. 6C, and the signature 2 undergoes a process illustrated in FIG. 6B.

The integration of verification results performed on each signature contained in a verification-target document file will now be described with reference to a flowchart illustrated in FIG. 6D. FIG. 6D is a flowchart that illustrates a process in which the document verification apparatus 1002 integrates verification results. The document verification apparatus 1002 executing the processing in this flowchart is subjected to centralized control of the CPU (not shown) incorporated therein.

In step 6301, the document verification apparatus determines whether the verification-target document file has been tampered with, with respect to the nth signature. If it is determined that tampering has been performed, flow proceeds to step 6304, where the “tampering verification result” is determined to be “tampered with,” and flow then proceeds to step 6302. If, in step 6301, it is determined that tampering has not been performed, flow proceeds to step 6302.

In step 6302, the document verification apparatus determines whether a certificate contained in the nth signature is invalid. If it is determined that the certificate is invalid, flow proceeds to step 6305, where the “certificate verification result” is determined to be “invalid certificate,” and flow then proceeds to step 6303. If, in step 6302, it is determined that the certificate is valid, flow proceeds to step 6303.

In step 6303, the document verification apparatus determines whether the verification-target document file has been edited, with respect to the nth signature. If it is determined that editing has been performed, flow proceeds to step 6306, where the “editing verification result” is determined to be “edited.”

Before the start of verification, the document verification apparatus 1002 sets in advance “not tampered with” as the “tampering verification result,” “valid” as the “certificate verification result,” and “not edited” as the “editing verification result.”

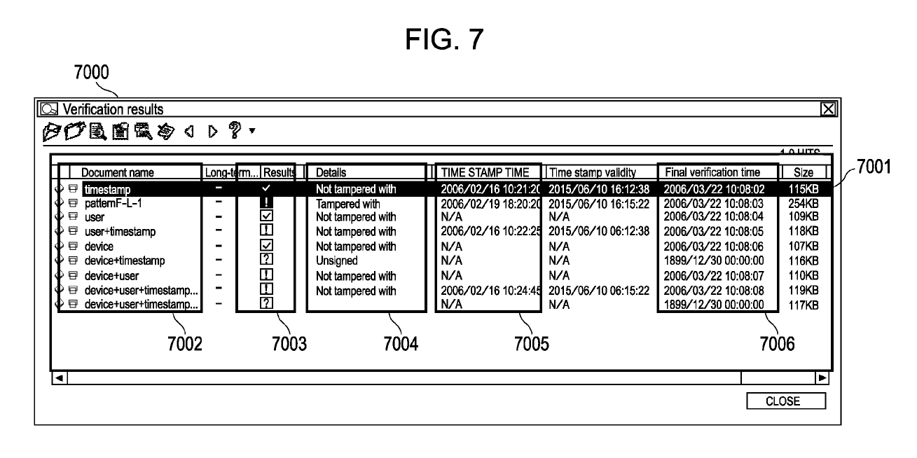

FIG. 7 illustrates a screen that displays a verification result. A verification-result display screen 7000 is an enlarged illustration that displays a verification result in the verification-result dialog 5006 after verification is performed. The verification-result display screen 7000 is also a dialog displayed on the display unit by the document verification apparatus 1002 after the document verification apparatus 1002 performs verification illustrated in FIG. 6A.

A verification-result display region 7001 includes the following areas: a document-name area 7002, an icon display area 7003, a details display area 7004, a timestamp-signature date and time display area 7005, and a final-verification date and time display area 7006.

The document-name area 7002 is an area for displaying the name of each document file.

The icon display area 7003 is an area for displaying results of verification of each document file by use of icons. Examples of the icons include a check-mark icon for indicating “valid,” an exclamation-mark icon (!) for indicating “there is a problem,” and a question-mark icon (?) for indicating “unverified.” The exclamation-mark icon, which indicates “there is a problem,” includes two kinds: one is an icon for indicating “tampered with” and the other is an icon for indicating “there is a problem other than tampering.” These two kinds of exclamation mark can be distinguished by being indicated with different colors.

The “valid” is provided to a document file determined to be “valid” as a result of verification in FIG. 6A.

The “there is a problem other than tampering” is provided to a document file determined to be “invalid certificate” or “edited” as a result of verification in FIG. 6A.

The “tampered with” is provided to a document file determined to be “tampered with” as a result of verification in FIG. 6A.

The “unverified” is provided to a document file that has not been subjected to verification in FIG. 6A.

The details display area 7004 displays the details of a verification result on the basis of the “tampering verification result,” “certificate verification result,” and “editing verification result” determined in FIG. 6D.

The timestamp-signature date and time display area 7005 displays the date and time of affixing a latest time signature.

The final-verification date and time display area 7006 displays the date and time of a latest verification of a document file.

As described above, in the present embodiment, when a signature that contains input optional information is detected, verification of a signature affixed prior to the detected signature is omitted. More specifically, only detection of tampering is performed, and verification of a certificate and detection of editing after signing are omitted.

Since the verification of a certificate and detection of editing after signing are omitted, verification of a document file can be quickly carried out.

Additionally, this prevents all document files that have a signature affixed by a device outside a system including a verification apparatus from being determined to be “invalid” for the reason that a certificate cannot be verified. A flexible system that performs possible verification on even such document files and obtains results of the verification can be realized.

A system according to the present embodiment includes a single document registration apparatus, a single document management server, and a single document verification apparatus, as illustrated in FIG. 1. However, the number of document registration apparatuses, that of document management servers, and that of document verification apparatuses are not limited to one.

The system may be designed so as to include a plurality of document registration apparatuses, document management servers, and document verification apparatuses as long as the apparatuses and servers can operate in cooperation with each other. The plurality of document registration apparatuses store the same hash function, the same private key, and the same certificate associated with the private key in respective storing units.

In this case, input optional information is attached when a document file is registered into any one of the document management servers via the plurality of document registration apparatuses.

In the present embodiment, operational flow of the document verification apparatus and document registration apparatus is described in flowcharts. A program that causes each apparatus to execute each step of the flowcharts is stored in a read-only memory (ROM), not shown, in the apparatus.

The CPU temporarily loads each program into a memory and executes processing in each flowchart in accordance with the loaded program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-166201 filed Jun. 15, 2006, which is hereby incorporated by reference herein in its entirety.

What is claimed is:

1. A signature verification apparatus comprising:
a determining unit configured to determine a type of a first signature affixed to a document file;
a first generating unit configured to, when the determining unit determines that the first signature is of a first type, check the validity of a certificate contained in the first signature in the document file, detect whether the document file has been tampered with based on the first signature, and generate a first verification result indicating whether the first signature is valid or invalid based on the check and the detection; and
a second generating unit configured to, when the determining unit determines that the first signature is of a second type, without checking the validity of a certificate contained in the first signature in the document file, detect whether the document file has been tampered with based on the first signature, and generate a second verification result indicating whether the first signature is valid or invalid based on the detection.

2. The signature verification apparatus according to claim 1, wherein the determining unit makes a determination as to which device affixed the first signature to the document file and determines the type of the first signature based on the determination as to which device affixed the first signature to the document file.

3. The signature verification apparatus according to claim 1, wherein the determining unit makes a determination as to when the first signature was affixed to the document file and determines the type of the first signature on the basis of the determination as to when the first signature was affixed to the document file.

4. The signature verification apparatus according to claim 1, wherein the determining unit makes a determination as to which device affixed the first signature to the document file, makes a determination as to when the first signature was affixed to the document file, and determines the type of the first signature based both the determinations of which device affixed the first signature to the document file and when the first signature was affixed to the document file.

5. The signature verification apparatus according to claim 1, wherein the determining unit includes a first detecting subunit configured to detect whether, after the first signature has been affixed to the document file, a second signature has been affixed to the document file and a second detecting subunit configured to, when the first detecting subunit detects that the second signature has been affixed to the document file after the first signature, detect whether the second signature has been affixed to the document file by a specific device,
wherein, in a case in which the first detecting subunit detects that the second signature has been affixed to the document file after the first signature has been affixed thereto and the second detecting subunit detects that the second signature has been affixed to the document file by a device other than the specific device, the determining unit determines the first signature is of the second type.

6. The signature verification apparatus according to claim 5, wherein, in cases other than the case in which the determining unit determines that the first signature is of the second type, the determining unit determines that the first signature is of the first type.

7. A signing apparatus comprising:
a receiving unit configured to receive a document file; and
a signing unit configured to sign the document file received by the receiving unit,
wherein the signing unit provides the document file with identifying information that distinguishes between a signature affixed before the document file is received by the receiving unit and a signature affixed after the document file is received by the receiving unit.

8. The signing apparatus according to claim 7, wherein the signing unit signs the document file received by the receiving unit such that the identifying information is contained in the document file.

9. The signing apparatus according to claim 7, wherein, in a case in which the document file has been received via the receiving unit, the signing unit signs the document file such that the identifying information is contained in the document file, and
in other cases, the signing unit signs the document file such that the identifying information is not contained in the document file.

10. A method for controlling a signature verification apparatus, the method comprising:
determining a type of a first signature affixed to a document file;
when the first signature is determined to be of a first type:
checking the validity of a certificate contained in the first signature in the document file;
detecting whether the document file has been tampered with based on the first signature; and
generating a first verification result indicating whether the first signature is valid or invalid based on the check of the validity of the certificate and the detection of whether the document has been tampered with; and
when the first signature is determined to be of a second type:
without checking the validity of a certificate contained in the first signature in the document file, detecting whether the document file has been tampered with based on the first signature; and
generating a second verification result indicating whether the first signature is valid or invalid based on the detection of whether the document file has been tampered with.

11. The method according to claim 10, wherein the type of first signature affixed to the document file is determined based on which device affixed the first signature to the document file.

12. The method according to claim 10, wherein the type of first signature affixed to the document file is determined based on when the first signature was affixed to the document file.

13. The method according to claim 10, wherein the type of first signature affixed to the document file is determined based on which device affixed the first signature to the document file and when the first signature was affixed to the document file.

14. The method according to claim 10, wherein determining the type of first signature affixed to the document file includes detecting whether, after the first signature has been affixed to the document file, a second signature has been affixed to the document file, and when it is detected that the second signature has been affixed to the document file after the first signature, detecting whether the second signature has been affixed to the document file by a specific device,
wherein, in a case in which it is detected that the second signature has been affixed to the document file after the first signature has been affixed thereto and it is detected that the second signature has been affixed to the document file by a device other than the specific device, it is determined that the first signature is of the second type.

15. The method according to claim 14, wherein, in cases other than the case where it is determined that the first signature is of the second type, it is determined that the first signature is of the first type.

16. A computer-readable storage medium storing a program that causes a computer to execute the steps in the method according to claim 10.

17. A method for controlling a signing apparatus, the method comprising:
receiving a document file; and
signing the received document file,
wherein the document file is provided with identifying information that distinguishes between a signature affixed before the document file is received and a signature affixed after the document file is received.

18. The method according to claim 17, wherein the document file received is signed such that the identifying information is contained in the document file.

19. The method according to claim 17, wherein, in a case in which the document file has been received, the document file is signed such that the identifying information is contained in the document file, and
in other cases, the document file is signed such that the identifying information is not contained in the document file.

20. A computer-readable storage medium storing a program that causes a computer to execute the steps in the method according to claim 17.
